(19) United States
(12) Patent Application Publication
(10) Pub. No.: US 2025/0005948 A1
(43) Pub. Date: Jan. 2, 2025

(54) AUTOMATIC COUNTING AT CHECKOUT USING MIX OF BARCODE DECODING AND MACHINE VISION

(71) Applicant: ZEBRA TECHNOLOGIES CORPORATION, Lincolnshire, IL (US)

(72) Inventors: Jason Y. Potter, New York, NY (US); Matthew Lawrence Horner, Sound Beach, NY (US)

(21) Appl. No.: 18/217,080

(22) Filed: Jun. 30, 2023

(51) Int. Cl. G06V 30/224; G07G 1/00

(52) U.S. Cl. CPC G06V 30/2247; G07G 1/0045

(57) ABSTRACT

Systems and methods for rapid product identification using barcode decoding and machine vision. An example scanning system includes a first imager configured to capture a first image of a first object and a second imager configured to capture a second image of a second object passing across a scanning area of an indicia reader. One or more processors are configured to analyze and decode an indicia within the first image, transmit the decoded first indicia value to a host, and store the first indicia value locally on the memory associated with the indicia reader. The processors may also determine whether the second object is substantially similar to the first object by comparing image data. The processors may also determine the second object is substantially similar to the first object and, in response, transmit the first indicia value to the host.

### BACKGROUND

Barcode scanning devices that include scanning systems are commonly utilized in many retail and other locations to facilitate customer checkout when decoding the barcode of an item passed across a scanning area. In instances where a customer is conducting a self-checkout and has more than one of the same item they wish to purchase, they are generally required to pick up each duplicate item to purchase, locate its barcode and scan the item with its barcode within the scanner's field of view to successfully record the item for purchase.

Accordingly, there is a need for rapidly identifying duplicate products during checkout in order minimize the time required to checkout with conventional devices.

### SUMMARY

Generally speaking, the scanning and/or imaging systems herein utilize multiple imagers to capture image data of a target object. In certain embodiments, a vision (imaging) assembly may be comprised of multiple imaging assemblies (imagers). In some embodiments, the multiple imagers may be a single imager with multiple imaging sensors e.g., a first imaging sensor configured for barcode scanning a second imaging sensor configured for visual imaging. In some embodiments, the multiple imagers may have one or more imaging sensors which are operatively connected (e.g., a first imager configured for barcode scanning a second imager configured for visual imaging). In some embodiments, the multiple imagers may be a single imager (single vision assembly) with a single imaging sensor (e.g., a single imaging sensor configured for both barcode scanning and visual imaging).

Accordingly, in an embodiment the present invention is a method for rapid product identification at checkout using mix of barcode decoding and machine vision. The method includes capturing a first image comprising first image data of a first object by a first imager having a first field of view of objects passing across a scanning area of an indicia reader; analyzing the first image data to decode a first indicia associated with a first object in the first image data, resulting in a first indicia value; transmitting the first indicia value to a host; storing the first indicia value locally on a memory associated with the indicia reader; capturing a second image comprising second image data of a second object by a second imager having a second field of view of the objects passing across the scanning area of the indicia reader; identifying the second object within the second image data; retrieving reference image data of the first object associated with the first indicia locally from the memory associated with the indicia reader; comparing the second image data to the reference image data to determine whether the second object is substantially similar to the first object; and responsive to determining the second object is substantially similar to the first object, transmitting the first indicia value to the host.

In a variation of this embodiment, responsive to determining that the second object is not substantially similar to the first object, the method may include capturing a third image comprising third image data of the second object by the first imager; analyzing the third image data to decode a second indicia associated with the second object in the third image data, resulting in a second indicia value; transmitting the second indicia value to a host; and storing the second indicia value locally on the memory associated with the indicia reader.

In another variation of this embodiment, the method may include capturing the second image and the third image substantially simultaneously.

In yet another variation of this embodiment, the method may include removing the one or more indicia values that are stored locally on the memory responsive to one or more of: (i) a completion of a scan session at the indicia reader, (ii) a reboot of the indicia reader, or (iii) the memory associated with the particular indicia reader exceeding a storage limit.

In still another variation of this embodiment, identifying the second object within the second image data may further include executing a machine vision algorithm locally on the indicia reader, the machine vision algorithm including one or more of: (i) edge detection, (ii) pattern matching, (iii) segmentation, (iv) color analysis, (v) optical character recognition (OCR), or (vi) blob detection.

In still another variation of this embodiment, storing the first indicia value locally on the memory associated with the indicia reader may further include retrieving one or more classified indicia values locally from the memory associated with the indicia reader; comparing the first indicia value to the one or more classified indicia values; and responsive to identifying a match between the first indicia value and a classified indicia value, one or more of: preventing the comparing of the second image data to the reference image data, or preventing the transmitting of the first indicia value to the host responsive to determining the second object is substantially similar to the first object.

In yet another variation of this embodiment, comparing the second image data to the reference image data to determine whether the second object is substantially similar to the first object may further include analyzing the second image data and the reference image data to generate a similarity value; comparing the similarity value to a threshold; and determining the second object is substantially similar to the first object based upon the similarity value at least reaching the threshold.

In still another variation of this embodiment, comparing the second image data to the reference image data to determine whether the second object is substantially similar to the first object may further include applying a similarity model to the second image data to generate the determination whether the second object is substantially similar to the first object, the similarity model being trained on historical object image data; updating the historical object image data to include the second image data; and retraining the similarity model based upon the updated historical object image data.

In yet another variation of this embodiment, the first imager is contained in a separate imaging device from the second imager.

In still another variation of this embodiment, transmitting the first indicia value to the host may further include transmitting the first indicia value to the host without decoding a second indicia associated with the second object.

In another embodiment, the present invention is a scanning system for rapid product identification comprising: a first imager having a first field of view of objects passing across a scanning area of an indicia reader configured to capture a first image comprising image data of a first object; a second imager having a second of view of the objects passing across the scanning area of the indicia reader configured to capture a second image comprising second image data of a second object; one or more processors; and a memory associated with the particular indicia reader storing instructions that, when executed by the one or more processors, cause the one or more processors to: analyze the first image data to decode a first indicia associated with a first object in the first image data, resulting in a first indicia value; transmit the first indicia value to a host; store the first indicia value locally on the memory associated with the indicia reader; identify the second object within the second image data; retrieve reference image data of the first object associated with the first indicia locally from the memory associated with the indicia reader; compare the second image data to the reference image data to determine whether the second object is substantially similar to the first object; and responsive to determining the second object is substantially similar to the first object, transmit the first indicia value to the host.

In a variation of this embodiment, the one or more processors are further configured to: responsive to determining that the second object is not substantially similar to the first object, cause the first imager to capture a third image comprising third image data of the second object: analyze the third image data to decode a second indicia associated with the second object in the third image data, resulting in a second indicia value; transmit the second indicia value to a host; and store the second indicia value locally on the memory associated with the indicia reader.

In another variation of this embodiment, the one or more processors are further configured to: cause the first imager and the second imager to substantially simultaneously capture the second image and the third image.

In a yet another variation of this embodiment, the one or more processors are further configured to: remove the one or more indicia values that are stored locally on the memory responsive to one or more of: (i) a completion of a scan session at the indicia reader, (ii) a reboot of the indicia reader, or (iii) the memory associated with the particular indicia reader exceeding a storage limit.

In still another variation of this embodiment, to identify the second object within the second image data, the one or more processors are further configured to execute a machine vision algorithm locally on the indicia reader, the machine vision algorithm including one or more of: (i) edge detection, (ii) pattern matching, (iii) segmentation, (iv) color analysis, (v) optical character recognition (OCR), or (vi) blob detection.

In yet variation of this embodiment, to store the first indicia value locally on the memory associated with the indicia reader, the one or more processors are further configured to: retrieve one or more classified indicia values locally from the memory associated with the indicia reader; compare the first indicia value to the one or more classified indicia values; and responsive to identifying a match between the first indicia value and a classified indicia value, one or more of: preventing the comparing of the second image data to the reference image data, or preventing the transmitting of the first indicia value to the host responsive to determining the second object is substantially similar to the first object.

In yet another variation of this embodiment, to compare the second image data to the reference image data to determine whether the second object is substantially similar to the first object, the one or more processors are further configured to: analyze the second image data and the reference image data to generate a similarity value; compare the similarity value to a threshold value; and determine the second object is substantially similar to the first object based upon the similarity value at least meeting the threshold value.

In still another variation of this embodiment, to compare the second image data to the reference image data to determine whether the second object is substantially similar to the first object, the one or more processors are further configured to: apply a similarity model to the second image data to generate a determination whether the second object is substantially similar to the first object, the similarity model being trained on historical object image data; update the historical object image data to include the second image data; and retrain the similarity model based upon the updated historical object image data.

In yet another variation of this embodiment, the first imager is contained in a separate imaging device from the second imager.

In another embodiment, the invention is a tangible machine-readable medium comprising instructions that, when executed, cause a machine to at least: capture a first image comprising first image data of a first object by a first imager having a first field of view of objects passing across a scanning area of an indicia reader; analyze the first image data to decode a first indicia associated with a first object in the first image data, resulting in a first indicia value; transmit the first indicia value to a host; store the first indicia value locally on a memory associated with the indicia reader; capture a second image comprising second image data of a second object by a second imager having a second field of view of the objects passing across the scanning area of the indicia reader; identify the second object within the second image data; retrieve reference image data of the first object associated with the first indicia from a local memory associated with the indicia reader; compare the second image data to the reference image data to determine whether the second object is substantially similar to the first object; and responsive to determining the second object is substantially similar to the first object, transmit the first indicia value to the host.

In another embodiment, the invention is a method for conducting machine vision processing. The method include capturing, by a vision assembly, first image data; transmitting the first image data to an indicia-decoding module; extracting, via the indicia-decoding module, an indicia payload associated with an indicia present in the first image data; determining a class of items based on the indicia payload; capturing, by the vision assembly, second image data; and selecting, from a set of reference vision data and based on the class of items, a subset of reference vision data for analysis against the second image data.

In a variation of this embodiment, the method includes providing the subset of reference vision data and the second image data to a comparison module; and determining whether an item captured in the second image data corresponds to an item in the subset of reference vision data.

In another variation of this embodiment, the method includes, responsive to determining that the item captured in the second image data corresponds to the item in the subset of reference vision data, transmitting data associated with the item in the subset of reference vision data to a host.

In yet another variation of this embodiment, transmitting the data associated with the item in the subset of reference vision data to the host occurs responsive to the indicia-decoding module being unable to extract an indicia payload associated with an indicia present in the second image data.

In still another variation of this embodiment, the instructions are executed by the one or more processors during a scan session of an indicia reader.

In another variation of this embodiment, the set of reference vision data is stored in a memory local to the indicia reader.

In yet another variation of this embodiment, the first image data is captured by a first imaging assembly of the vision assembly, and wherein the second image data is captured by a second imaging assembly of the vision assembly.

In another embodiment, a system for machine vision processing. The system includes a vision assembly; an indicia-decoding module; one of more processors; and a memory storing instructions that, when executed by the one or more processors, cause the system to: capture, by the vision assembly, first image data; transmit the first image data to the indicia-decoding module; extract, via the indicia-decoding module, an indicia payload associated with an indicia present in the first image data; determine a class of items based on the indicia payload; capture, by the vision assembly, second image data; and select, from a set of reference vision data and based on the class of items, a subset of reference vision data for analysis against the second image data.

In a variation of this embodiment, the system includes a comparison module, wherein the memory further stores instructions that, when executed by the one or more processors, cause the system to: provide the subset of reference vision data and the second image data to the comparison module; and determine whether an item captured in the second image data corresponds to an item in the subset of reference vision data.

In another variation of this embodiment, the memory further stores instructions that, when executed by the one or more processors, cause the system to: responsive to determining that the item captured in the second image data corresponds to the item in the subset of reference vision data, transmit data associated with the item in the subset of reference vision data to a host.

In yet another variation of this embodiment, transmitting the data associated with the item in the subset of reference vision data to the host occurs responsive to the indicia-decoding module being unable to extract an indicia payload associated with an indicia present in the second image data.

In still another variation of this embodiment, the instructions are executed by the one or more processors during a scan session of an indicia reader.

In yet another variation of this embodiment, the vision assembly includes a first imaging assembly and a second imaging assembly, wherein the first image data is captured by the first imaging assembly, and wherein the second image data is captured by the second imaging assembly.

In another embodiment, an indicia reader including a vision assembly; an indicia-decoding module; one of more processors; and a memory storing instructions that, when executed by the one or more processors, cause the indicia reader to: capture, by the vision assembly, first image data; transmit the first image data to the indicia-decoding module; extract, via the indicia-decoding module, an indicia payload associated with an indicia present in the first image data; determine a class of items based on the indicia payload; capture, by the vision assembly, second image data; and select, from a set of reference vision data and based on the class of items, a subset of reference vision data for analysis against the second image data.

In a variation of this embodiment, the indicia reader includes a comparison module, wherein the memory further stores instructions that, when executed by the one or more processors, cause the indicia reader to: provide the subset of reference vision data and the second image data to the comparison module; and determine whether an item captured in the second image data corresponds to an item in the subset of reference vision data.

In another variation of this embodiment, the memory further stores instructions that, when executed by the one or more processors, cause the indicia reader to: responsive to determining that the item captured in the second image data corresponds to the item in the subset of reference vision data, transmit data associated with the item in the subset of reference vision data to a host.

In yet another variation of this embodiment, the transmitting the data associated with the item in the subset of reference vision data to the host occurs responsive to the indicia-decoding module being unable to extract an indicia payload associated with an indicia present in the second image data.

In still another variation of this embodiment, the method is performed during a scan session of the indicia reader.

In yet another variation of this embodiment, the vision assembly includes a first imaging assembly and a second imaging assembly, wherein the first image data is captured by the first imaging assembly, and wherein the second image data is captured by the second imaging assembly.

In still another variation of this embodiment, the set of reference vision data is stored in a memory local to the indicia reader.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A is a perspective view of an example indicia reader that may be used to implement inventive concepts described here.

FIG. 1B is a perspective view of another example barcode reader that may be used to implement inventive concepts described here.

FIG. 1C is a perspective view of another example barcode reader that may be used to implement inventive concepts described here.

FIG. 1D illustrates a profile view of an example scanning system that includes a first imager and a second imager, in accordance with embodiments disclosed herein.

FIG. 2A is a block diagram of an example logic circuit for implementing example methods and/or operations described herein.

FIG. 2B is an example workflow block diagram for rapid product identification, in accordance with embodiments described herein.

FIG. 3 illustrates an example method for rapid product identification, in accordance with embodiments disclosed herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As previously mentioned, when purchasing two or more of the same items, a customer at a self-checkout station must scan the identical barcodes of each duplicate item across a scanning area of the scanner. Thus, conventional barcode scanning devices generally suffer from slowly and tediously identifying duplicate products after an original product has been scanned.

Therefore, it is an objective of the present disclosure to provide systems and methods capable of rapidly identifying duplicate products during a checkout session using a mix of barcode decoding and machine vision. As a result, POS stations may operate more efficiently during a scan session by eliminating duplicitous scanning processes, scan session durations (and by proxy, checkout times) may be significantly reduced, customers may correspondingly save time and effort, and customers may receive a more efficient and enjoyable checkout experience.

Additionally, it should be understood that, the indicia and indicia scanning/decoding methods are referenced herein primarily as a barcode and barcode scanning/decoding for the purposes of discussion only. The systems and methods of the present disclosure may apply to any indicia (e.g., barcodes, quick response (QR) codes, a graphic, a logo, etc.) associated with an object.

In particular, the techniques of the present disclosure provide solutions to the issues experienced with conventional barcode scanning devices. As an example, the techniques of the present disclosure alleviate these issues by introducing a scanning system for rapid product identification that includes a first imager (also referred to as an first imaging assembly) configured to capture, analyze and decode a first indicia value within a first image of a first object, and a second imager (also referred to as a second imaging assembly) configured to capture, identify, analyze and compare a second image of a second object to a reference image of the first object to determine whether the objects are substantially similar. These components enable the computing system to rapidly identify duplicate products using image comparison rather than barcode scanning alone. Based on a determination of substantial similarity, the components may also enable the computing system to transmit the first indicia value to the host, such as a POS; and if not, using the first imager, capture, analyze and decode a second indicia value in a third image of the second object to transmit the second indicia value to a host. In this manner, the techniques of the present disclosure enable efficient, rapid, accurate identification and counting of duplicate items being scanned without requiring additional barcode scanning.

Accordingly, the present disclosure includes improvements in computer functionality relating to identifying duplicate products by describing techniques for rapidly identifying duplicate products using mix of barcode decoding and machine vision. That is, the present disclosure describes improvements in the functioning of a scanning system and the present disclosure improves the state of the art at least because previous scanning and/or imaging systems typically lacked enhancements described in the present disclosure, including without limitation, enhancements relating to duplicate product identification described throughout the present disclosure.

In addition, the present disclosure includes applying various features and functionality, as described herein, with, or by use of, a particular machine, e.g., a first imager and/or a second imager and/or other components as described herein.

Moreover, the present disclosure includes specific features other than what is well-understood, routine, conventional activity in the field, or adding unconventional steps that demonstrate, in various embodiments, particular useful applications, e.g., capturing a first image comprising first image data of a first object by a first imager having a first field of view of objects passing across a scanning area of an indicia reader; analyzing the first image data to decode a first indicia associated with a first object in the first image data, resulting in a first indicia value; transmitting the first indicia value to a host; storing the first indicia value locally on a memory associated with the indicia reader; capturing a second image comprising second image data of a second object by a second imager having a second field of view of the objects passing across the scanning area of the indicia reader; identifying the second object within the second image data; retrieving reference image data of the first object associated with the first indicia locally from the memory associated with the indicia reader; comparing the second image data to the reference image data to determine whether the second object is substantially similar to the first object; and responsive to determining the second object is substantially similar to the first object, transmitting the first indicia value to the host.

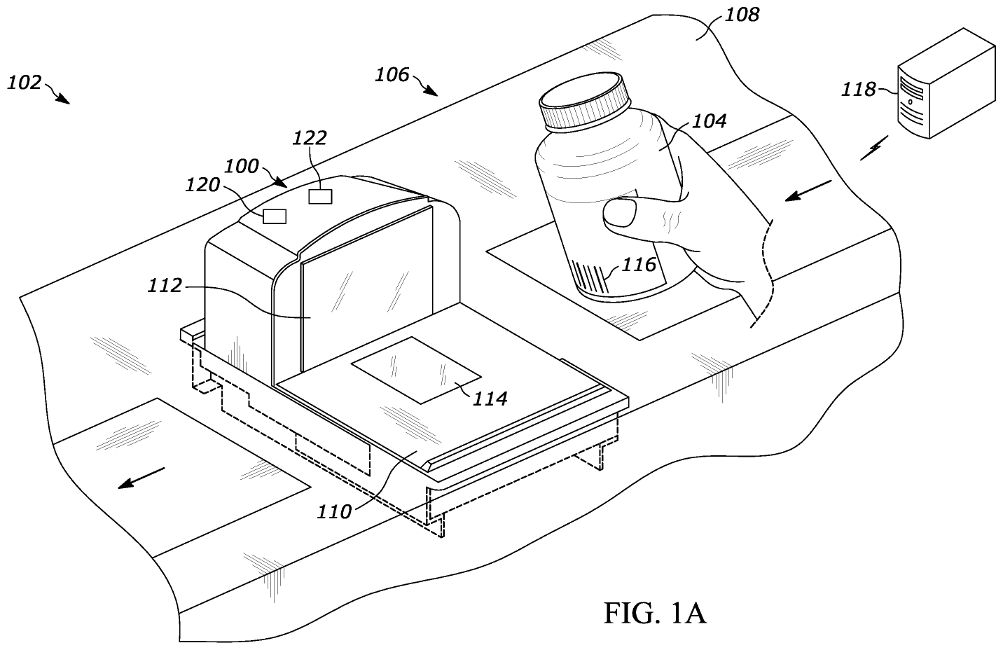

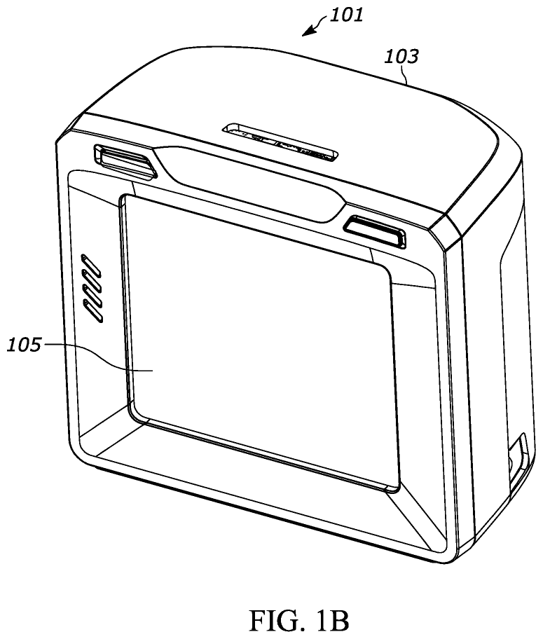

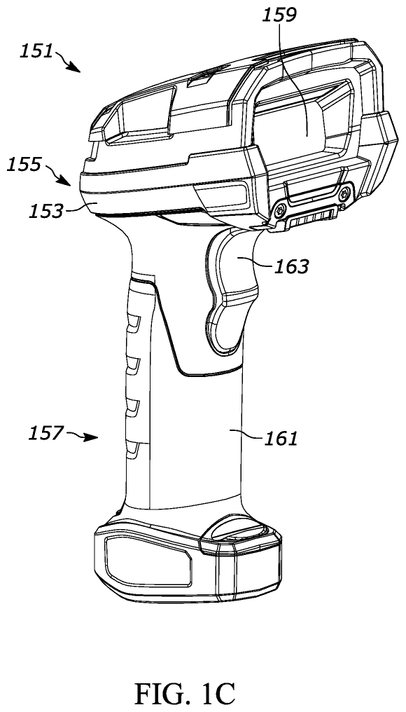

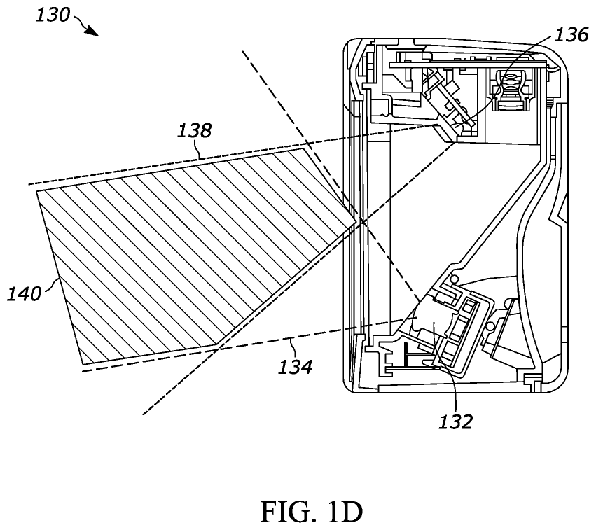

FIG. 1A is a perspective view of a prior art bioptic indicia reader 100, implemented in a prior art point-of-sale (POS) system 102, showing capture of an image of a target object 104 being swiped across the indicia reader 100 scanning area. The POS system 102 includes a workstation 106 with a counter 108, and the indicia reader 100. The indicia reader 100 includes a weighing platter 110, which may be removable or non-removable. Typically, a customer or store clerk will pass the target object 104 from in a general direction, in the illustrated example right-to-left, across at least one of a substantially vertical imaging window 112 or a substantially horizontal imaging window 114 to enable the indicia reader 100 to capture one or more images of the target object 104, including the barcode 116.

As part of the customer or clerk passing the target object 104 across the imaging windows 112, 114, the indicia reader 100 may trigger an illumination source 120 included in the indicia reader 100 to emit illumination, and for an imaging sensor 122 to capture image data of the target object 104 and/or the barcode 116. The indicia reader 100 is operable to capture image data of sufficient quality to perform imaging-based operations like decoding a barcode 116 that appears in the obtained image data. It should be appreciated that while items may be swiped past the indicia reader 100 in either direction, items may also be presented into the product scanning area by means other than swiping past the window(s). When the target object 104 comes into the any of the fields of view of the indicia reader 100, the barcode 116 on the target object 104 is captured and decoded by the indicia reader 100, and corresponding data (e.g., the payload of the indicia) is transmitted to a communicatively coupled host 118 (commonly comprised of a point-of-sale (POS) terminal).

FIG. 1B illustrates another example of an indicia reader 101, sometimes referred to as a slot scanner. In the example shown, indicia reader 101 has a housing 103 and a window 105, which faces a product scanning area, to allow a set of optical components positioned within housing 103 to direct at least one field-of-view through window 105. Indicia reader 101 operates on a similar principle as the indicia reader 100 of FIG. 1A. However, it is generally smaller (typically having a window that is smaller than 5 inches across), includes a single window, and, while it could be installed in a slot of a counter (functioning like the bottom portion of the bioptic indicia reader 100), it can also be used as a stationary scanner positioned on a working surface (functioning like the upper portion of the bioptic indicia reader 100).

FIG. 1C illustrates yet another example of an indicia reader 151, sometimes referred to as a handheld indicia reader. Reader 151 generally includes a housing 153 that is comprised of a head portion 155 and a bottom portion 157. The head portion 155 houses at least some optoelectrical components for capturing relevant image data along a field of view (FOV) that extends through a window 159. The bottom portion 157 typically includes a handle portion 161 and a trigger 163. In operation, a user typically grasps the handle portion 161 and points the reader 151 in a general direction of the indicia that is to be read. If the reader is configured to be activated with the activation of the trigger 163, subsequent to the user squeezing the trigger 163, reader 151 captures relevant image data and processes it accordingly.

While it will be appreciated that concepts described herein may be used in connection with any of the indicia reader embodiments described above, this should not be considered limiting and it should be understood that other form factors of indicia readers could be employed.

The conventional indicia reader 100 of FIG. 1A is generally unable to rapidly identify a product which may be a duplicate of an already-scanned product without repeating the aforementioned scanning procedure, including requiring the POS system 102 to scan the duplicate barcode of each associated duplicate product even though it has previously scanned the barcode on the original product. As a result, undue time is spent by the POS system 102 and the user scanning one or more duplicate products having barcodes which the POS system 102 has previously scanned and identified.

To overcome this issue, FIG. 1D depicts a profile view of an embodiment of a rapid product identification scanning system, in accordance with embodiments described herein. It should be appreciated that the embodiment of the rapid product identification scanning system described herein is for the purposes of discussion only. The rapid product identification scanning system may describe only a portion of the rapid product identification scanning system (e.g., implemented in a particular retail location), and the entire rapid product identification scanning system may include some/all of the rapid product identification scanning system to identify products. For example, the second imager of the rapid product identification scanning system may be depicted as within the same housing as the first imager, however in other embodiments the first and second imagers may be separately located and operably connected.

Generally speaking, the rapid product identification system may be implemented via a bioptic indicia reader 130, although other scanning systems may be within the scope of the invention. As depicted in FIG. 1D, the bioptic indicia reader 130 may include a first imager 132 configured to capture a first image comprising first image data of a first object, such as object 104. The first imager 132 may include a scanner that is configured to detect and decode barcodes and/or other object indicia. In some embodiments, the first imager 132 may be implemented with a dedicated indicia scanner, such as a indicia reader 100 of FIG. 1A, to detect and/or decode barcodes of items scanned for purchase. The first imager 132 may be oriented to have a first FOV 134 of objects passing across the scanning area.

The bioptic indicia reader 130 may include a second imager 136 configured to capture a second image comprising second image data of a second object. In some embodiments, the second imager 136 may be implemented with one or more vision cameras. In certain embodiments, the second imager 136 (e.g., vison camera) may be oriented to have a second FOV 138 of the scanning area, which may create an overlap region 140 with at least a portion of the first FOV 134 of the first imager 132 (e.g., barcode reader). In other embodiments, the second imager 136 may be located separately from the first imager 132 (e.g., the first imager 132 is contained in a separate imager from the second imager 136), while still having a second FOV 138 of objects passing over the scanning area. Additionally, the barcode of the object being scanned does not need to be within the second FOV 138 of the second imager 136, as the second imager 136 may not be configured and/or required to detect a barcode to identify an object. As a result, the second imager 136 may be positioned in the bioptic indicia reader 130 with greater flexibility than the first imager 132. In some embodiments, the multiple imagers may be a single imager with a single imaging sensor (e.g., a single imaging sensor configured for barcode scanning and visual imaging). The single imager may have a single FOV of objects passing over the scanning area and may be configured for indicia decoding and visual imaging (e.g., machine vision analysis) of the images captured by the single imager.

In some embodiments, the bioptic indicia reader 130 imagers 132, 136 may capture image data in their respective FOVs 134, 138, such that the rapid product identification system may capture image data using both/either imagers 132, 136 for indicia decoding/machine vision analysis when a user passes an object through the overlap region 140. The image capture through the overlap region 140 may enable the bioptic indicia reader 130 to rapidly perform the object identification described herein by attempting to perform object recognition machine vision techniques first via the second imager 136, and if those fail for the reasons described herein, can immediately rely on the image data captured by the first imager 132 to identify/decode visible indicia.

The bioptic indicia reader 130, first and/or second imager 132, 136, and/or any other suitable processing device may include an application (e.g., object identification module or image comparison module) to track, identify and/or compare the objects which have passed though the scanning area. In these embodiments, the vision camera and the barcode scanner may collectively monitor for objects passing through the scanning area.

The bioptic indicia reader 130 and/or other suitable processors may analyze the first image data to decode a first indicia within the first image data. In an example, an image processing application of the bioptic indicia reader 130 may decode the barcode when the processor loads an indicia decoder from memory to process the first image data. The indicia may comprise an encoded indicia value as, for example, is the case with a 1D or 2D barcode where the barcode encodes an indicia value comprised of, for example, alphanumeric or special characters that may be formed into a string. Decoding the first indicia associated with the first object in the first image data may result in a first indicia value.

At one or more times and/or during one or more processes, such as when analyzing the first image data and/or decoding an indicia, the (decoded) indicia may be associated with one or more reference images/image data, e.g., reference image data used to determine whether the second object is substantially similar to the first object. For example, the (decoded) indicia may be associated with an object e.g., via an object description, manufacturer identifier, and/or other suitable manner of associating the (decoded) indicia with an object. A reference image/image data may likewise be associated with an object, which may include an association in a same and/or similar manner as the (decoded) indicia, e.g., via an object description, manufacturer identifier, and/or other suitable manner of association, such that comparing, matching, cross-referencing, etc., the object's (decoded) indicia association and reference image/image data association may result in an association between one or more (decoded) indicia and one or more reference images/image data. Accordingly, the bioptic indicia reader 130 may transmit a decoded indicia value (e.g., to a host) for an object substantially similar to one already-scanned (e.g., based upon the substantially similar object's reference image), without having decoded an indicia of the substantially similar object.

In one aspect, analyzing the image data and/or decoding an indicia may include extracting, via the indicia decoder (also referred to as an indicia decoding module), an indicia payload associated with an indicia present in image data. The indicia payload may indicate a class of items (e.g., cereal, dairy, produce, or any other suitable class of items). The class of items indicated by the indicia payload (e.g., a decoded indicia value) may be associated with one or more reference images/reference image data, such as a subset of reference image data (also referred to as vision data). For example, a decoded indicia/payload for bleach may be associated with class of items including cleaning products. Accordingly, the reference image data/vision data associated with the decoded indicia/payload may be a subset of image data/vision data associated with bleach and/or cleaning products.

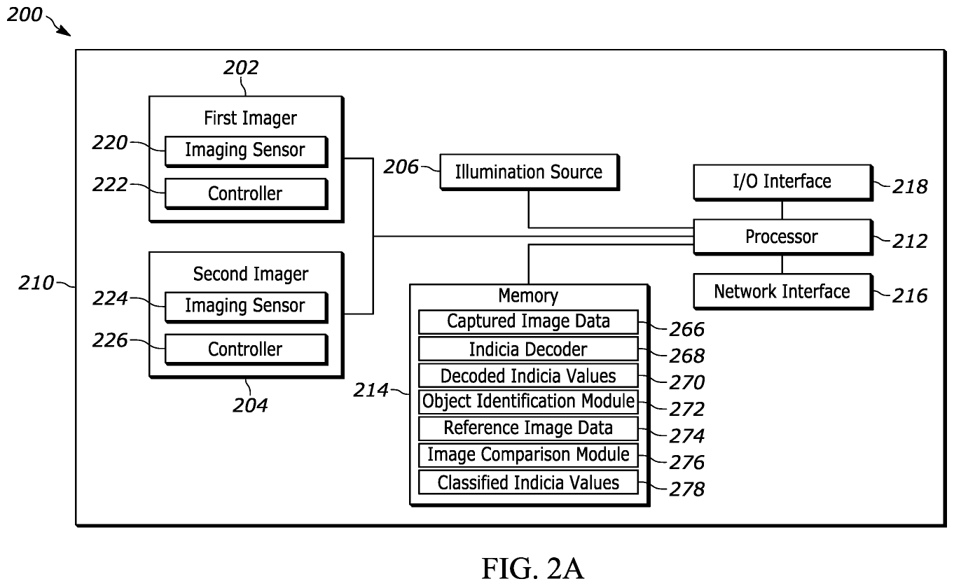

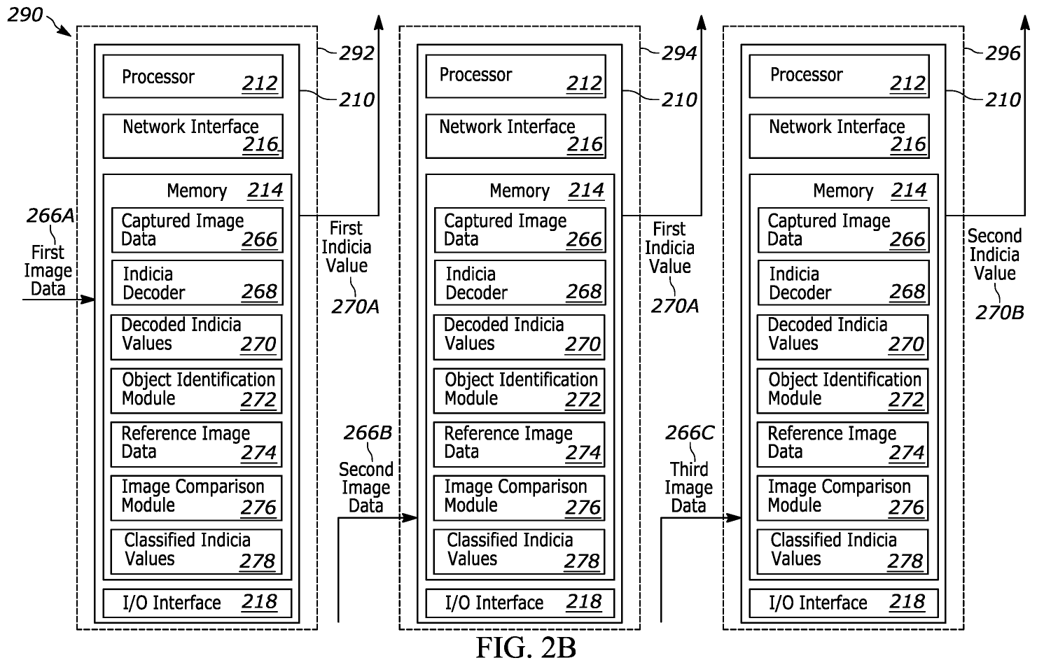

The bioptic indicia reader 130 may transmit the first indicia value to a host, such as host 118, which may include a POS system. For example, the first indicia value may be used by the POS system to tally items a user is scanning with the bioptic indicia reader 130 for purchase during a scan session. The bioptic indicia reader 130 and/or other suitable processors may store the first indicia value locally on a memory associated with the bioptic indicia reader 130 as described further with respect to FIG. 2A. The memory may include a database, a memory module, as well as any other suitable memory.

The bioptic indicia reader 130 may retrieve a reference image data of the first object associated with the first indicia. The reference image data (e.g., which may represent a “golden image”) may be image data comprising an ideal and/or preferred image of an object to be used as a reference for comparison with other images, e.g., when implementing machine vision and/or object recognition with image data. The reference image data may be obtained locally from the memory associated with the bioptic indicia reader 130 as described further with respect to FIG. 2A. The reference image data may be created and/or built by way of capturing one or more images of an object via the bioptic indicia reader 130. For example, one or more images of an object comprising image data may be captured via the first imager 132 and/or second imager 136 as the object is being passed across the scanning area, which the bioptic indicia reader 130 may use and/or store (e.g., in a reference image database in local memory) as reference image data. The reference image data may include one or more reference images. For example, one or more images of an object in various positions which may accommodate comparing images of an object scanned in any position across the scanning area of bioptic indicia reader 130. In another example, a product may include updated labeling and a reference image may include one or more images with the previous label and one or more images with the updated label, both of which may be used for image comparison, as products with both labels may be available for scanning by a user at the bioptic indicia reader 130. In another example, a reference image may be associated with a piece of produce such as a banana which may have a varied appearance based on how ripe the fruit is (e.g., color, spots, etc.), and its reference image may include multiple images representative of various stages of ripeness of the banana.

One or more of reference images and/or reference image data may be associated with one or more (decoded) indicia, e.g., the indicia of the object of the reference image. For example, the reference image/image data and the (decoded) indicia may be associated via tags, metadata, pointers associated with the reference image/image data, an indicia within the reference image/image data, a storage location of the reference image/image data, a look-up table, a database, and/or via any other suitable method of associating a reference image/image data with the (decoded) indicia. The association between a reference image/image data and one or more indicia may be made at a time previous to, during, or after a scanning session.

In an embodiment, the bioptic indicia reader 130 may identify the second object within the second image data. Identifying an object, such as the second object, within the image data, such as the second image data, may include identifying one or more of the location, position, boundary, edge(s), outline, feature(s) and/or other suitable features, characteristics, qualities, etc., of an object in image data. For example, identifying an object may include identifying that the object, such as an object of interest, is either present (in whole or in part) or not present within an image and/or image data. In some aspects, identifying an object within image data may not include identifying what the object is, but rather at least only whether an object is present within the image data.

In an example, identifying the second object within the second image data may include applying/executing a machine vision algorithm on the second image data. This may include executing the machine vision algorithm locally on the bioptic indicia reader 130. More specifically, in this example, the machine vision algorithm may include one or more of: (i) edge detection, (ii) pattern matching, (iii) segmentation, (iv) color analysis, (v) optical character recognition (OCR), or (vi) blob detection, any and/or all of which may be included as part of an object identification module.

The bioptic indicia reader 130 may compare the second image data to the reference image data to determine whether the second object is substantially similar to the first object, i.e., whether the second object may resemble the first object without necessarily being identical. The comparison of the image data may include one or more applications, image comparison modules, algorithms, machine learning, or any other suitable manner of image comparison to determine substantial similarity. The discussed techniques for image comparison may beneficially operate more quickly, accurately and/or efficiently in comparison to scanning and decoding the indicia of each duplicate product with the first imager 132.

In an embodiment, in comparing the second image data to the reference image data to determine substantial similarity, the bioptic indicia reader 130 may analyze the second image data and the reference image data to generate a similarity value. In some implementations, the similarity value may be a numerical value. For example, a value between zero (0) and one (1), where zero (0) means no/low similarity and one (1) means high/identical similarity. The bioptic reader 130 may compare the similarity value to a threshold value and determine the second object is substantially similar to the first object based upon the similarity value at least meeting the threshold value. The threshold value may be a value saved in memory, such as a memory local to the bioptic indicia reader 130. In an example, this may include comparing data representing one or more pixels of an image, as well as any other suitable techniques.

In another embodiment, in comparing the second image data to the reference image data to determine substantial similarity, the bioptic indicia reader 130 may apply a similarity model (e.g., machine learning model) to the second image data to generate a determination whether the second object is substantially similar to the first object. The similarity model may be trained on historical object image data, e.g., images of objects which are likely to be scanned by the bioptic indicia reader 130. The bioptic indicia reader 130 may update the historical object image data to include the second image data, and subsequently retraining the similarity model based upon the updated historical object image data. Benefits of embodiments implementing machine learning for image comparison may include increased speed, accuracy, and/or improvement over time due to updated training data and/or model retraining.

It will be appreciated that comparing image data may include, or be limited to, image processing, transformation, and/or other suitable manipulation(s) of image data which may allow for comparison of the image data, the images associated with the image data, objects within images/image data, etc., especially to determine substantial similarity of objects within the images/image data.

Responsive to determining the second object is substantially similar to the first object, the bioptic indicia reader 130 may transmit the first indicia value to the host, such as a POS system. In one aspect, the indicia value may be associated with the reference image/image data used to establish substantial similarity of objects, such that the indicia value (e.g., first indicia value) is known to bioptic indicia reader 130 upon determining substantial similarity of an object (e.g., the second object). The association between the indicia value and reference image/image data may allow for transmission of the indicia value (e.g., the first indicia value) by the bioptic indicia reader 130 to the host without having to image and/or decode an indicia associated with the substantially similar (e.g., second) object. For example, the determination of substantial similarity may indicate that the second object is a duplicate of an already-scanned first object and accordingly, the indicia and indicia value of the first object would be a duplicate of the second object. As such, transmitting the first indicia value to the host accounts for scanning the substantially similar second object without having to decode its indicia, and the bioptic indicia reader 130 may beneficially operate more quickly, accurately and/or efficiently in comparison to scanning and decoding the indicia of each duplicate product with the first imager 132.

In some embodiments, after determining that the second object is substantially similar to the first object and accordingly transmitting the first indicia value to the host for the second object, the user may pass one or more subsequent objects through the overlap region 140 across the scanning area and the bioptic indicia reader 130 may continue to capture subsequent images for each of the one or more subsequent objects with the second imager 136 (e.g., vision camera) until the bioptic indicia reader 130 determines that at least one of the subsequent objects is not substantially similar to one or more previously scanned objects. For each subsequent object which is scanned, the bioptic indicia reader 130 may identify the subsequent object in the associated subsequent image data captured by the second imager 136, retrieve reference image data of one or more previously scanned objects locally from the memory associated with the bioptic indicia reader 130, and compare the subsequent image data to the reference image data to determine whether the subsequent object is substantially similar to one or more previously scanned objects. Responsive to determining the subsequent object is substantially similar to one or more previously scanned objects, the bioptic indicia reader 130 may transmit the indicia value associated with the substantially similar previously scanned object to the host. The indicia value associated with the substantially similar previously scanned object may be stored in local memory, e.g., after the previously scanned object was initially scanned with the first imager 132. This process may continue ad infinitum until the bioptic indicia reader 130 determines that at least one of the subsequent objects is not substantially similar to one or more previously scanned objects.

In some embodiments where a third object is substantially similar to the previously scanned first and second objects, the bioptic indicia reader 130 may capture a third image comprising third image data of the third object by the second imager 136 (e.g., vision camera) having a second field of view of the objects passing across the scanning area of the bioptic indicia reader 130. The bioptic indicia reader 130 may identify the third object within the third image data, as previously described. The bioptic indicia reader 130 may compare the third image data to reference image data of the previously scanned first and/or second object, after retrieving the reference image data of the previously scanned first and/or second object locally from memory, to determine whether the third object is substantially similar to the previously scanned first and/or second object. Responsive to determining the third object is substantially similar to at least one of the previously scanned first and/or second object, the bioptic indicia reader 130 may transmit the indicia value of the substantially similar previously scanned first and/or second object to the host, such as a POS system. The determination of substantial similarity may indicate that the third object is a duplicate of the previously scanned first and/or second object during the same scan session, and accordingly, the indicia value of the previously scanned substantially similar first and/or second object would be a duplicate of the third object. As such, transmitting the previously scanned first and/or second object's indicia value to the host accounts for scanning the third object without having to decode its indicia, and the bioptic indicia reader 130 may beneficially operate more quickly, accurately and/or efficiently in comparison to scanning and decoding the indicia of each duplicate product with the first imager 132.

For example, a user may purchase five (5) identical boxes of tissues. The bioptic indicia reader 130 via the first imager 132 may capture an image comprising image data of the first box of tissues and analyze the image data to decode an indicia associated with the first box of tissues in the image data, resulting in a decoded indicia value for the first box of tissues. The bioptic indicia reader 130 may transmit the first tissue box indicia value to a host and store the first tissue box indicia value locally on a memory associated with the bioptic indicia reader 130. Assuming the user scans the next four (4) tissue boxes directly after the first tissue box, the bioptic indicia reader 130 may capture images of each of the remaining four (4) tissues boxes via the second imager 136 only, and process (i.e., identify each of the four (4) tissue boxes; retrieve the reference image data of the first tissue box; determine substantial similarity of each of the remaining four (4) tissue boxes with the first tissue box; transmit indicia values of the first tissue box to the host for each of the four (4) tissue boxes, etc.) without decoding their barcodes.

In some embodiments, where multiple objects have been previously scanned, the bioptic indicia reader 130 may capture image data of an instant, presently scanned object with the second imager 136 and compare the image data of the presently scanned object to reference data of any previously scanned object to determine whether the presently scanned object is substantially similar to a previously scanned object. Upon detecting substantial similarity between a presently scanned object and a previously scanned object using the previously described techniques, the bioptic indicia reader 130 may transmit the indicia value of the previously scanned object which is substantially similar to the presently scanned object to the host, such as a POS system. The discussed techniques for image comparison may beneficially operate more quickly, accurately and/or efficiently in comparison to scanning and decoding the indicia of each duplicate product with the first imager 132.

Responsive to determining that the second object is not substantially similar to the first object, the bioptic indicia reader 130 may capture a third image comprising third image data of the second object. The third image and associated third image data may be captured by the first imager 132 (e.g., scanner). Similar to analyzing the first image data to decode a first indicia associated with a first object in the first image data, the bioptic indicia reader 130 may analyze the third image data to decode a second indicia associated with the second object in the third image data, resulting in a second indicia value. Also similar to scanning the first object, the bioptic indicia reader 130 may transmit the second indicia value to a host, such as host 118, and/or store the second indicia value locally on the memory associated with the bioptic indicia reader 130. In an example, determining that the second object is not substantially similar to the first object may indicate the second object has not previously been scanned by the first imager 132 and/or is not a duplicate of a previously scanned object. Accordingly, the first imager 132 (e.g., scanner) may image the second object, identify and decode the associated indicia (barcode), and transmit the second indicia value to a host/POS system to tally the second object for purchase by the user, and/or save the second indicia value to a local memory. The bioptic indicia reader 130 may thereby account for the second object being scanned and also rapidly detect scans of forthcoming objects using the second imager 136 (e.g., vision camera) which may be duplicates of the second object.

In some aspects, a system, such as the bioptic indicia reader 130 having a vision assembly, may extract via the indicia decoder an indicia value or payload associated with an indicia present in the first image data captured by the vision assembly. The system may determine a class of items based on the indicia payload, as described herein. The vision assembly may capture second image data, and the system may select a subset of reference image data (e.g., from reference image data stored in a local memory), based on the class of items. The system may provide the subset of reference image data and the second image data to a comparison module and determine whether an object and/or item captured in the second image data corresponds to an item and/or object in the subset of reference vision data, e.g., to determine substantial similarity.

Responsive to determining that the item/object captured in the second image data corresponds/is substantially similar to the item/object in the subset of reference vision data, the system may transmit data associated with the item/object in the subset of reference vision data (e.g., an indicia value or indicia payload), to a host. Transmitting the data associated with the item in the subset of reference vision data to the host may be responsive to the indicia decoder being unable to extract an indicia payload associated with an indicia present in the second image data.

In some embodiments, the bioptic indicia reader 130 may cause the first imager 132 and the second imager 136 to substantially simultaneously capture the second image and the third image. This may include capturing the second and third images at the same time, nearly the same time, and/or with timing such that both the second and third images may each be captured by the bioptic indicia reader 130 for their intended purpose without the user having to move the second object through the scanning area more than once. In such an example, capturing the second and third images at substantially the same time may further accelerate checkout at a bioptic indicia reader 130 and appear seamless to the user in doing so, especially when the second object may not be substantially similar to the first object.

In some embodiments, storing the first indicia value locally on the memory associated with the bioptic indicia reader 130 may further include retrieving one or more classified indicia values locally from the memory associated with the bioptic indicia reader 130. The classified indicia values may be associated with one or more classes of objects. In an aspect, the objects associated with the classified indicia values may include objects which, e.g., a system administrator, may restrict the bioptic indicia reader 130 from identifying using the second imager 136, e.g., vision camera. For example, organic produce may cost more money per unit than comparable non-organic produce, and the image comparison techniques for these objects may not accurately capture what is being scanned due to how similar both types of produce appear. To alleviate this problem, the bioptic indicia reader 130 compares the first indicia value to the classified indicia values, and if the bioptic indicia reader 130 identifies a match between the first indicia value and a classified indicia value, it may either prevent comparing of the second image data to the reference image data and/or prevent the transmitting of the first indicia value to the host if it determines the second object is substantially similar to the first object. In either case, using classified indicia/barcodes may eliminate the possibility of transmitting indicia to a host for objects which the second imager 136 identifies as similar to a first object, but in actuality are different types of objects. When comparing and identifying a match between a first indicia and a classified indicia, and as a result preventing comparing of the preventing the second image and reference image data and/or preventing the first indicia from being transmitted to the host (e.g., a POS system), the bioptic indicia reader 130 may subsequently capture image data of the second object associated with the second indicia with the first imager 132 (e.g., scanner), and in the process ensure the second object of the second indicia is properly identified and scanned by the bioptic indicia reader 130.

In some embodiments, the user may scan objects as part of a scan session during which they purchase one or more items as part of a single transaction. The bioptic indicia reader 130 may determine the completion of a scan session (i.e., when the user has completed their checkout) in one of several ways, such as the bioptic indicia reader 130 measuring an idle period greater than a threshold idle period during which no objects are scanned, when a new person is captured in images by the bioptic indicia reader 130, etc. In an embodiment, the bioptic indicia reader 130 may remove the indicia values that are stored locally on the memory when (i) a scan session at the bioptic indicia reader 130 is completed (e.g., once a user has finished scanning all the items they wish to purchase at the bioptic indicia reader 130), (ii) the bioptic indicia reader 130 reboots (e.g., due to loss of power, a system fault, a user initiated reboot, etc.) and/or (iii) the memory associated with the particular bioptic indicia reader 130 exceeds a storage limit. As the bioptic indicia reader 130 local memory may have limited capacity, the bioptic indicia reader 130 may at one or more times delete indicia values. Clearing the indicia values from the memory, e.g., at the end of a scan session, may free up memory and/or provide faster checkout times for a user, as the bioptic indicia reader 130 will only be processing, among other things, images, data and/or indicia values associated with objects scanned during an instant scan session, rather than previous scan sessions.

More generally, the components of the bioptic indicia reader 130 may be or include various additional components/devices. For example, the imagers 132, 136 may include a housing positioned to direct the fields of view of the various imagers 132, 136 in particular directions to capture image data. In some examples, the first imager 132 (first imaging assembly) is contained in a separate assembly (e.g., a vision assembly), imager and/or housing from the second imager 136 (second imaging assembly). In some examples, the first imager 132 (first imaging assembly) is contained in the same vision assembly, imager and/or housing as the second imager 136 (second imaging assembly). Additionally, while the bioptic indicia reader 130 of FIG. 1D may be described as pertaining to a retail environment, more generally the bioptic indicia reader 130 may be deployed in any of a variety of environments including a warehouse facility, a distribution center, etc.

FIG. 2A is a block diagram representative of an example logic circuit 200 capable of implementing, for example, one or more components of the example bioptic indicia reader 130 of FIG. 1D. The example logic circuit 200 of FIG. 2A is a processing platform 210 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

As illustrated in FIG. 2A, the imagers 202, 204 may include one or more imaging sensor(s) 220, 224. In particular, each of the first imager 202 and/or the second imager 204 may include one or more sensors configured to capture image data corresponding to a target object, an indicia associated with the target object, and/or any other suitable image data. The imagers 202, 204 may be any suitable type of imager, such as a barcode scanner, a slot scanner, a vision camera, an original equipment manufacturer (OEM) scanner inside of a kiosk, a handle/handheld scanner, and/or any other suitable imager type.

As an example, the first imager 202 may be or include a barcode scanner with one or more barcode imaging sensors, such as imaging sensor 220, that are configured to capture image data representative of an environment appearing within a field of view of the first imager 202, such as one or more images of an indicia associated with a target object. The second imager 204 may be or include a vision camera with one or more visual imaging sensors, such as imaging sensor 224, that are configured to capture image data representative of an environment appearing within a field of view of the second imager 204, such as one or more images of the target object.

The first imager 202 and/or the second imager 204 may each include one or more subcomponents, such as one or more controllers 222, 226 to control and/or perform operations of the first imager 202 and second imager 204 respectively. The first imager 202 and/or the second imager 204 may further include one or more imaging shutters (not shown) that are configured to enable the imagers 202, 204 to capture image data corresponding to, for example, a target object and/or an indicia associated with the target object. It should be appreciated that the imaging shutters included as part of the imagers 202, 204 may be electronic and/or mechanical shutters configured to expose/shield the imaging sensors 220, 224 of the imagers 202, 204 from the external environment. In particular, the imaging shutters that may be included as part of the imagers 202, 204 may function as electronic shutters that clear photosites of the imaging sensors 220, 224 at a beginning of an exposure period of the respective sensors.

In operation, the imagers 202, 204 may capture image data as captured image data 266 which may comprise 1-dimensional (1D) and/or 2-dimensional (2D) images of a target object, including, for example, packages, products, or other target objects that may or may not include indicia such as barcodes, QR codes, or other such labels for identifying such packages, products, or other target objects, which may be, in some examples, merchandise available at retail/wholesale store, facility, or the like. The processor 212 of the example logic circuit 200 may thereafter analyze the captured image data 266 of target objects and/or indicia passing through a field of view of the imagers 202, 204.

This captured image data 266 may be utilized by the processor 212 make some/all of the determinations described herein. For example, the indicia decoder 268, object identification module 272, and/or image comparison module 276 may include executable instructions that cause the processor 212 to perform some/all of the analyses and determinations described herein. The analyses and determinations may include the captured image data 266, decoded indicia values 270, reference image data 274 and/or classified indicia values 278, as well as any other data collected by or from the first imager 202 and/or the second imager 204.

Namely, a first imager 202 having a first FOV of objects passing across a scanning area of an indicia reader, such as bioptic indicia reader 130, may capture a first image. The first image may comprise first image data of a first object, which may be stored in memory 214. The indicia decoder 268 may direct the processor 212 to decode a first indicia associated with a first object in the first image data, resulting in a decoded first indicia value. The first indicia value may be stored in memory 214. The processor 212 may also transmit the first indicia value to a host, such as host 118, e.g., via the network interface 216. For example, the processing platform 210 may transmit the first indicia value to a POS system so that a customer is charged for purchasing the first object.

The second imager 204 having a second FOV of objects passing across the scanning area of the indicia reader may then capture a second image, the second image comprising second image data of a second object. The second image data may be stored in memory 214. The object identification module 272 may direct the processor 212 to identify the second object within the second image data. The image comparison module 276 may direct the processor 212 to compare the second image data of the second object to the reference image data 274 of the first object. The image comparison may include the processor 212 retrieving the reference image data 274 of the first object, e.g., locally from memory 214 associated with the indicia reader. The image comparison module 276 may determine whether the second object is substantially similar to the first object.

Responsive to determining the second object is substantially similar to the first object, the processor 212 may transmit the first indicia value data to the host, e.g., via the network interface 216. Similar to the previous example, the processing platform 210 may transmit the first indicia value to a POS system so that the customer is charged a second time for purchasing the second object, which is substantially similar to the first object. Using the second imager 204 and image comparison module 276 to tally the number of items for purchase by a customer at a POS system may provide a faster checkout experience for the customer than if using only the first imager 202 alone to scan all items for purchase.

Responsive to determining that the second object is not substantially similar to the first object, the first imager 202 may capture a third image comprising third image data of the second object. The third mage data may be stored in memory 214. The indicia decoder 268 may direct the processor 212 to analyze and decode a second indicia within the third image data. The processor 212 may obtain a decoded second indicia value based on decoding the second indicia, and transmit the second indicia value to the host, e.g., via the network interface 216. The processor 212 may also store the second indicia value in memory 214. Similar to the example of the first indicia, the processing platform 210 may transmit the second indicia value to a POS system so that a customer is charged for purchasing the second object. The example processing platform 210 of FIG. 2A includes a processor 212 such as, for example, one or more microprocessors, controllers, and/or any suitable type of processor.

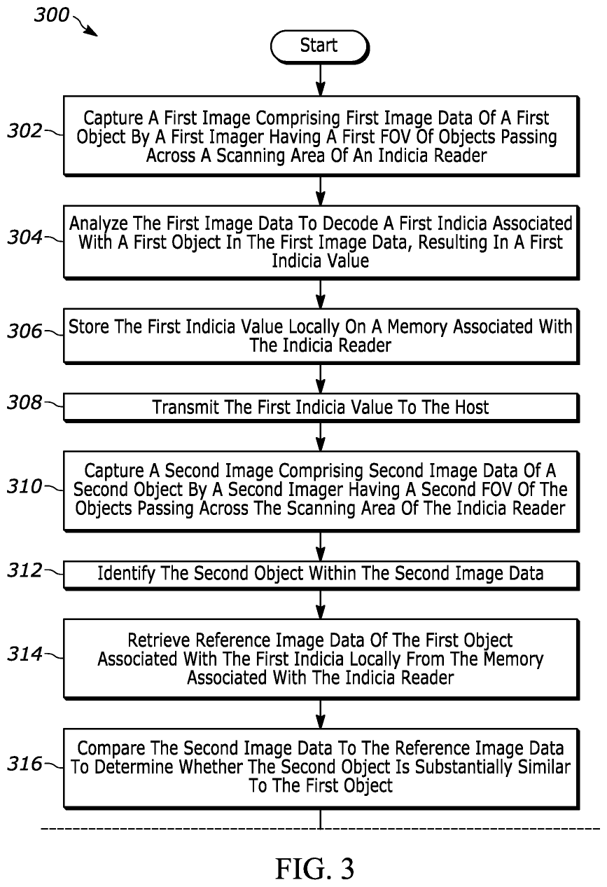

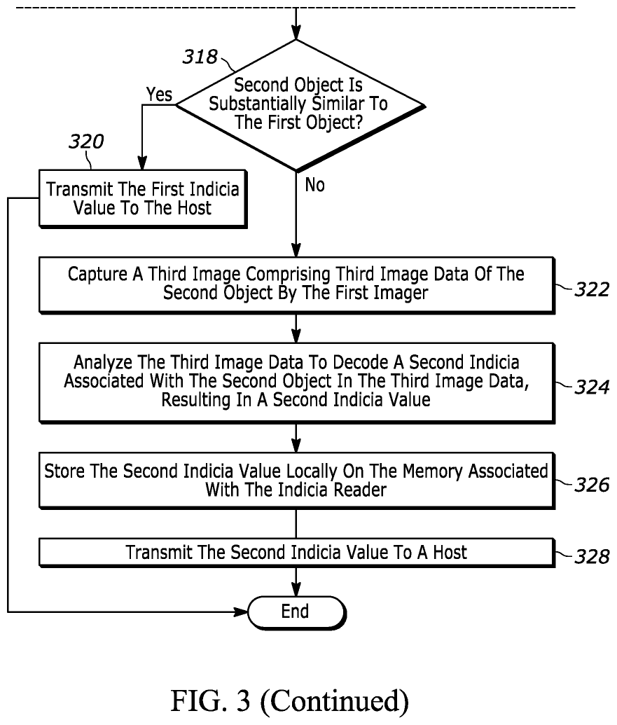

The example processing platform 210 of FIG. 2A includes memory (e.g., volatile memory, non-volatile memory) 214 accessible by the processor 212 (e.g., via a memory controller). The processor 212 and the memory 214 may be included within the housing of an indicia reader, such as bioptic indicia reader 130. The example processor 212 interacts with the memory 214 to obtain, for example, machine-readable instructions stored in the memory 214 corresponding to, for example, the operations represented by the flowcharts of this disclosure, such as the flowchart of FIG. 3. The example processor 212 may also interact with the memory 214 to obtain, or store, data and/or instructions related to the first imager 202, the second imager 204, and/or the shared illumination source 206. In particular, the instructions stored in the memory 214, when executed by the processor 212, may cause the processor 212 to receive and analyze data and signals generated by the imagers 202, 204. For example, the memory 214 may include an indicia decoder 268 and an object identification module 272 which may analyze captured image data 266 from images captured by imagers 202, 204 to at least decode indicia and identify objects within the captured image data 266. Additionally, or alternatively, machine-readable instructions corresponding to the example operations described herein may be stored on one or more removable media (e.g., a compact disc, a digital versatile disc, removable flash memory, etc.) that may be coupled to the processing platform 210 to provide access to the machine-readable instructions stored thereon.

Generally speaking, executing the indicia decoder 268 may include analyzing images that include the indicia (e.g., as captured by the imager 202 which may be an indicia scanner) in order to decode the indicia, resulting in a decoded indicia value 270, which may be stored in memory 214. For instance, in some examples, decoded indicia values 270 may be alphanumeric codes or values associated with each indicia, such as barcode 116. Moreover, in some examples, decoded indicia values 270 may include indications of items to which the indicia is affixed, e.g., items corresponding to the alphanumeric codes or values associated with each indicia.

Generally speaking, the object identification module 272 may include identifying an object in captured image data 266, such as captured image data 266 from an image captured by a machine vision camera (e.g., second imager 204). In one embodiment, the object identification module 272 may include executing a machine vision algorithm locally on the indicia reader and/or processing platform 210, the machine vision algorithm including one or more of: (i) edge detection, (ii) pattern matching, (iii) segmentation, (iv) color analysis, (v) optical character recognition (OCR), or (vi) blob detection.

Generally speaking, the image comparison module 276 may include comparing captured image data 266 to determine whether objects within the captured image data 266 are substantially similar, e.g., comparing second image data of a second image from second imager 204 to the first object reference image data of a first object to determine whether the second object is substantially similar to the first object. In some embodiments, the image comparison module 276 may include analyzing the second image data and the first object reference image data to generate a similarity value, comparing the similarity value to a threshold, and determining the second object is substantially similar to the first object based upon the similarity value at least reaching the threshold, as previously described. In some embodiments, the image comparison module 276 may include applying a similarity model to the second image data to generate the determination whether the second object is substantially similar to the first object, the similarity model being trained on historical object image data, updating the historical object image data to include the second image data, and retraining the similarity model based upon the updated historical object image data, as further described herein.

Given the limited capacity of the memory 214, processing platform 210 may subsequently delete the decoded indicia values 270 and/or captured image data 266 at various intervals, such as at the completion of each scan session at the bioptic indicia reader 130 (which may be determined, e.g., by the bioptic indicia reader 130 measuring an idle period greater than a threshold idle period, identifying a new person in the images captured by an imager, such as machine vision camera of the second imager 204, etc.), at each reboot of the bioptic indicia reader 130, based on a storage limit of the memory 214 being exceeded, etc. Deleting the decoded indicia values 270 and/or captured image data 266 may improve the speed of the scan session, e.g., resulting in only images and/or indicia captured in a single scan session being used for comparison purposes, such as comparing captured image data 266 to reference image data 274, comparing decoded indicia values 270 to classified indicia values 278, etc.

The processing platform 210 may also include an illumination source 206 that is generally configured to emit illumination during a predetermined period corresponding to captured image data 266 capture of the imagers 202, 204. In some embodiments, the first imager 202 and/or the second imager 204 may use and/or include color sensors and the illumination source 206 may emit white light illumination. Additionally, or alternatively, the first imager 202 and/or the second imager 204 may use and/or include a monochrome sensor configured to capture captured image data 266 of an indicia associated with the target object in a particular wavelength or wavelength range (e.g., 600 nanometers (nm)-700 nm). The illumination source may correspondingly emit particular wavelengths (e.g., red wavelengths, IR) to suit the requirements of the imagers.

The example processing platform 210 of FIG. 2A may also include a network interface 216 to enable communication with other machines via, for example, one or more networks. The example network interface 216 includes any suitable type of communication interface(s) (e.g., wired and/or wireless interfaces) configured to operate in accordance with any suitable protocol(s). For example, in some embodiments, networking interface 216 may transmit data or information (e.g., captured image data 266, decoded indicia values 270, etc.) between remote processor(s) and/or a remote server, such as host 118, and processing platform 210.

The example processing platform 210 of FIG. 2A may also include input/output (I/O) interfaces 218 to enable receipt of user input and/or communication of output data to the user.

Any/all of the aforementioned data may be used by the processor 212 to determine various outputs. For example, FIG. 2B is an example workflow block diagram 290 for rapid product identification, in accordance with embodiments described herein. The example workflow 290 generally illustrates various data received/retrieved/obtained by the processing platform 210 that is utilized by the computer-executable instructions (e.g., object identification module 272, image comparison module 276) stored in memory 214 as inputs to generate various outputs.

At a first time frame 292, the various data received by the processing platform 210 includes captured first image data 266A, and the processing platform 210 may output the decoded first indicia value 270A. At a second time frame 294, the processing platform 210 may receive the captured second image data 266B and retrieve from local memory reference image data 274 of the first object, and the processing platform 210 may output the decoded first indicia value 270A. At a third time frame 296, the processing platform 210 may receive captured third image data 266C, and the processing platform 210 may output the decoded second indicia value 270B.

Thus, the inputs/outputs of the processing platform 210 at the first time frame 292 may generally represent the processing platform 210 (i) receiving the captured first image data 266A of a first object from the first imager 202, (ii) analyzing and decoding a first indicia within the captured first image data 266A via the indicia decoder 268 resulting in a decoded first indicia value 270A which may be stored in local memory 214, as well as interpreting the outputs to transmit the decoded first indicia value 270A to the host (e.g., a POS system) via network interface 216.

The inputs/outputs of the processing platform 210 at the second time frame 294 may generally represent the processing platform 210 (i) receiving the captured second image data 266B of a second object from the second imager 204, (ii) identifying the second object within the captured second image data 266B via object identification module 272, and (iii) comparing the captured second image data 266B to the reference image data 274 of the first object in local memory 214 via image comparison module 276 to determine whether the second object is substantially similar to the first object; as well as and interpreting the outputs from the first time frame 292 to transmit (for a second time) the decoded first indicia value 270A to the host via network interface 216 in response to determining the second object is substantially similar to the first object.

The inputs/outputs of the processing platform 210 at the third time frame 296 may generally represent, responsive to determining that the second object is not substantially similar to the first object, (i) receiving the captured third image data 266C of a second object captured by the first imager 202, (ii) analyzing and decoding a second indicia within the captured third image data 266C input via the indicia decoder 268 resulting in a decoded second indicia value 270B which may be stored in local memory 214, as well as and interpreting the outputs to transmit the decoded second indicia value 270B to the host via network interface 216. Of course, it should be understood that the inputs/outputs illustrated in FIG. 2B are for the purposes of discussion only and may not represent and/or include every input/output.

In one example, a user of the processing platform 210 is purchasing two boxes of different kinds of cereal. At the first time frame 292, the user may swipe a first cereal box across the FOV of the first imager 202 and second imager 204, thereby causing the first imager 202 to capture the first image of the first cereal box comprising captured first image data 266A of the first cereal box. The processing platform 210 may analyze and decode the first indicia within the captured first image data 266A via indicia decoder 268 resulting in a decoded first indicia value 270A which is saved in local memory 214, and transmit the decoded first indicia value 270A to the host, such as host 118, via network interface 216.

At the second time frame 294, the user may swipe a second cereal box (that is different from the first cereal box) across the FOV of the first imager 202 and second imager 204. The processing platform 210 may (i) capture with the second imager 204 a second image of the second cereal box comprising captured second image data 266B, (ii) identify the second cereal box within the captured second image data 266B (e.g., using machine vision) via object identification module 272, (iii) retrieve a reference image 274 of the first cereal box locally from memory 214, and (iv) compare the second cereal box captured second image data 266B to the first cereal box reference image 274 data via image comparison module 276 to determine whether the second cereal box is substantially similar to the first cereal box. In one aspect, determining substantial similarity may include analyzing the captured second image data 266B and the reference image data 274 to generate a similarity value and comparing the similarity value to a threshold, and if the similarity value at least reaches the threshold, determine the first cereal box is substantially similar to the second cereal box. In other embodiments, determining substantial similarity may include applying a similar model to the captured second image data 266B to generate the determination whether the second cereal box is substantially similar to the first cereal box, the similarity model being trained on historical object image data (e.g., images of cereal boxes). This embodiment may further include updating the historical object image data to include the second cereal box image data 266B and retraining the similarity model based upon the updated historical object image data. Updating the training data and retraining the model may improve the operation of the similarity model over time.

At the third time frame 296, responsive to determining that the second cereal box is not substantially similar to the first cereal box, the first imager 202 may capture a third image comprising captured third image data 266C of the second cereal box, which in some instances may require the user to swipe the second cereal box across the FOV of the first imager 202 a second time, and in other instances the second and third images are captured substantially simultaneously eliminating the need for the user to swipe the second cereal box across the FOV of the first imager 202 a second time.

At the third time frame 296, the processing platform 210 may analyze the captured third image data 266C to decode via indicia decoder 268 a second indicia associated with the second cereal box in the captured third image data 266C, resulting in a decoded second indicia value 270B which may stored in local memory 214. The processing platform 210 may transmit the decoded second indicia value 270B to a host via the network interface 216. The decoded second indicia value 270B in memory 212 may be used if, in the future during the same scan session, one or more additional second cereal boxes are passed across the scanning area, in which case the processing platform 210 may transmit the decoded second indicia value 270B stored in memory 214 to the host after recognizing the subsequent cereal box(es) as substantially similar to the second cereal box. The processing platform 210 may recognize an association between an indicia and a substantially similar object (e.g., via associations between a decoded indicia and a reference image of the substantially similar object as described herein), allowing the processing platform 210 to seamlessly transmit the decoded second indicia value 270B upon recognizing subsequent cereal boxes.

In another example, a user of the processing platform 210 is purchasing two cans of the same soup. At the first time frame 292, a user may swipe a first soup can across the FOV of the first imager 202 and second imager 204, thereby causing the first imager 202 to capture captured first image data 266A of the first soup can. The processing platform 210 may analyze the captured first image data 266A to decode via the indicia decoder 268 the first indicia associated with the first soup can, resulting in a decoded first indicia value 270A which may be stored locally in memory 214. The processing platform 210 may transmit the decoded first indicia value 270A to a host.

At the second time frame 294, the user may swipe a second soup can (that is the same as the first soup can) across the FOV of the first imager 202 and second imager 204. The processing platform 210 may capture with the second imager 204 a second image of the second soup can comprising captured second image data 266B, identify the second soup can within the captured second image data 266B via object identification module 272 (e.g., using machine vision). The processing platform 210 may retrieve reference image data 274 of the first soup can locally from memory 214, and compare the captured second image data 266B of the second soup can to the reference image data 274 of the first soup can to determine whether the second soup can is substantially similar to the first soup can via image comparison module 276 (e.g., using a similarity model or similarity value comparison). At the third time frame 296, responsive to determining the second soup can is substantially similar to the first soup can, the processing platform 210 may transmit the decoded first indicia value 270A to the host, such as a POS system. This may include transmitting the decoded first indicia value 270A to the host without decoding a second indicia associated with the second object/soup can, which may further decrease the time of the scan session of the user, as the processing platform 210 associates the first indicia value 270A with the second object/soup can, as previously described (e.g., associating the reference image of the soup can with the decoded indicia for the soup can)

In yet another example, a user of the processing platform 210 may be purchasing one non-organic avocado and one organic avocado. At the first time frame 292, a user may swipe a first (non-organic) avocado across the FOV of the first imager 202 and second imager 204, thereby causing the first imager 202 to capture captured first image data 266A of the first (non-organic) avocado. The processing platform 210 may analyze the captured first image data 266A to decode via the indicia decoder 268 a first indicia associated with the first (non-organic) avocado, resulting in a decoded first indicia value 270A which may be stored in local memory 214. The processing platform 210 may transmit the decoded first indicia value 270A to the host via network interface 216.

At the second time frame 294, the processing platform 210 may retrieve classified indicia values 278 locally from memory 214. The classified indicia values 278 may represent indicia values corresponding to objects that appear substantially similar to one or more other, different objects, such that the object identification module 272 may be unable to correctly identify the objects as distinct and different from one another (e.g., organic product versus non-organic produce). The processing platform 210 may compare the decoded first indicia value 270A associated with the first non-organic avocado to the classified indicia values 278. In this example, the classified indicia values 278 include the indicia values for both non-organic avocados and organic avocados, as both may appear substantially similar to one another even though the two products are different and/or have different indicia (e.g., different barcodes due to different prices for each item). Responsive to identifying a match between the decoded first indicia value 270A and a classified indicia value 278, when a second and/or subsequent avocado is scanned, the processing platform 210 may prevent the comparing of the second/subsequent image data 266B of a second/subsequent avocado to the reference image data 274 of the first (non-organic) avocado having a decoded first indicia value 270A matching a classified indicia value 278. Also responsive to identifying a match between the decoded first indicia value 270A and a classified indicia value 278, the processing platform 210 may prevent the transmitting of the decoded first indicia value 270A of the first (non-organic) avocado to the host responsive to determining the second/subsequent avocado is substantially similar to the first (non-organic) avocado alternatively, or in addition to, preventing the comparing of the second/subsequent image data 266B of a second/subsequent avocado to the reference image data 274 of the first (non-organic) avocado having a decoded first indicia value 270A matching a classified indicia value 278.

Continuing with the avocado example, at the second time frame 294, the user may swipe the second (organic) avocado across the FOV of the first imager 202 and second imager 204. If the processing platform 210 captures a second image comprising captured second image data 266B of a the second (organic) avocado by the second imager 204, due to the restrictions previously described from matching the first (non-organic) avocado decoded first indicia value 270A with the classified indicia value 278, the processing platform 210 at time frame 296 may capture a third image comprising captured third image data 266C of the second (organic) avocado by the first imager 202, analyze the captured third image data 266C to decode via the indicia decoder 268 a second indicia associated with the second (organic) avocado in the third image data 266C, resulting in a decoded second indicia value 270B which may be stored in local memory 214, and transmit the decoded second indicia value 270B to a host via the network interface 216. Due to the restrictions from matching with a classified indicia value 278, the processing platform 210 may carry out the same time sequences as if determining the first and second objects are not substantially similar. This may include imaging the objects with the first imager 202 only and/or foregoing determining substantial similarity of the two objects using image data 266B from the second imager 204, and may also include decoding and transmitting to a host the decoded indicia values 270A, 270B for each respective object. As with previous examples, if the second imager 204 and the first imager 202 capture captured second image data 266B and captured third image data 266C of the second object respectively after determining a match between a decoded indicia value 270A of a first object and a classified indicia value 278, the processing platform 210 may capture the second image and the third image substantially simultaneously, thereby expediting the scan session for the user.

In certain instances, the processing platform 210 may remove one or more decoded indicia values 270 that are stored locally on the memory 214 responsive to, as previously described, one or more of: (i) a completion of a scan session at the indicia reader and/or processing platform 210, (ii) a reboot of the indicia reader and/or processing platform 210, or (iii) the memory 214 associated with the particular indicia reader and/or processing platform 210 exceeding a storage limit.

In other examples, identifying the second object within the captured second image data 266B (e.g., from one or more images captured by the second imager 204, such as a machine vision camera) by the processing platform 210 may include the one or more processors (e.g., processor 212) configured to use a machine vision algorithm which may include one or more of: (i) edge detection, (ii) pattern matching, (iii) segmentation, (iv) color analysis, (v) optical character recognition (OCR), or (vi) blob detection.

In some examples, the first imager 202 and the second imager 204 may substantially simultaneously (e.g., during the same time frame, nearly the same time frame, or one time frame directly subsequent to another) capture the second image and the third image as inputs, as previously described.

In other examples, in comparing the captured second image data 266B to the reference image data 274 to determine whether the second object is substantially similar to the first object, the processing platform 210 may include the one or more processors (e.g., processor 212) configured to analyze the captured second image data 266B and the reference image data 274 to generate a similarity value as inputs; compare the similarity value to a threshold value; and output a determination the second object is substantially similar to the first object based upon the similarity value at least meeting the threshold value, e.g. which may include image comparison module 276.

In yet other examples, comparing the captured second image data 266B to the reference image data 274 of a first object to determine whether the second object is substantially similar to the first object, which may include image comparison module 276, may include the one or more processors (e.g., processor 212) applying a machine learning similarity model to the second image data as an input, and to generate/output a determination whether the second object is substantially similar to the first object. The machine learning model may be stored in memory (e.g., memory 214) and loaded at runtime by processor (e.g., processor 212) into image comparison module 276. The similarity model may be trained using historical object image data as an input, such as image data of objects which may be passed across the scanning area, e.g., objects for purchase a store, objects associated with indicia of an indicia reader (indicia reader 100) and/or a POS system, etc. The processing platform 210 may update the historical object image data to include the second image data and output a retrained similarity model based upon the updated historical object image data. Accordingly, the processing platform 210 may utilize the updated historical object image data in a feedback loop that enables the processing platform 210 to retrain the similarity model, which may improve the accuracy of the similarity model and/or reduce time of the scan session.

Generally, machine learning may involve identifying and recognizing patterns and/or objects in existing data (such as historical object image data) in order to facilitate making predictions or object identification for subsequent data (such as comparing the captured second image data 266B to the first object reference image data 274 to determine whether the second object is substantially similar to the first object). Machine learning model(s), may be created and trained based upon example data (e.g., “training data”) inputs or data (which may be termed “features” and “labels”) in order to make valid and reliable predictions for new inputs, such as testing level or production level data or inputs.

More specifically, the machine learning model that may be included as part of the object identification module 272 and/or image comparison module 276 may be trained using one or more supervised machine learning techniques. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based on the discovered rules, relationships, or model, an expected output.

For example, in certain aspects, the supervised machine learning model may employ a neural network, which may be a convolutional neural network (CNN), a deep learning neural network, or a combined learning module or program that learns in two or more features or feature datasets (e.g., prediction values) in particular areas of interest. The machine learning programs or algorithms may also include natural language processing, semantic analysis, automatic reasoning, support vector machine (SVM) analysis, decision tree analysis, random forest analysis, K-Nearest neighbor analysis, naïve Bayes analysis, clustering, reinforcement learning, and/or other machine learning algorithms and/or techniques. In some aspects, the artificial intelligence and/or machine learning based algorithms may be included as a library or package executed on the processing platform 210. For example, libraries may include the TENSORFLOW based library, the PYTORCH library, and/or the SCIKIT-LEARN Python library.

The supervised machine learning model may be configured to receive image data as input (e.g., second image data) and output identifying characteristics as a result of the training performed using the plurality of historical object image data training which may include image data, identifying characteristics, and the corresponding ground truth identifying characteristics. The output of the supervised machine learning model during the training process may be compared with the corresponding ground truth identifying characteristics. In this manner, the object identification module 272 may accurately and consistently generate identifying characteristics that identify the objects imaged by the imagers 202, 204 and/or determining substantial similarity between objects via image data 266, because the differences between the training identifying characteristics and the corresponding ground truth identifying characteristics may be used to modify/adjust and/or otherwise inform the weights/values of the supervised machine learning model (e.g., an error/cost function).

As previously mentioned, machine learning may generally involve identifying and recognizing patterns in existing data (such as generating training data identifying characteristics of objects based on training image data) in order to facilitate making predictions or identification for subsequent data (such as using the similarity model on new image data indicative of objects to determine or generate identifying characteristics of the objects to determine substantial similarity between objects).

Additionally, or alternatively, in certain aspects, the machine learning model included as part of the object identification module 272, image comparison module 276, may be trained using one or more unsupervised machine learning techniques. In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated.

It should be understood that the unsupervised machine learning model included as part of the object identification module 272 and/or image comparison module 276 may be comprised of any suitable unsupervised machine learning model, such as a neural network, which may be a deep belief network, Hebbian learning, or the like, as well as method of moments, principal component analysis, independent component analysis, isolation forest, any suitable clustering model, and/or any suitable combination thereof.

It should be understood that, while described herein as being trained using a supervised/unsupervised learning technique, in certain aspects, the Al based learning models described herein may be trained using multiple supervised/unsupervised machine learning techniques. Moreover, it should be appreciated that the identifying characteristic generations may be performed by a supervised/unsupervised machine learning model and/or any other suitable type of machine learning model or combinations thereof.

FIG. 3 illustrates an example rapid product identification method 300, in accordance with embodiments disclosed herein. The method 300 includes capturing a first image comprising first image data of a first object by a first imager (e.g., first imager 132, 202) having a first FOV of objects passing across a scanning area of an indicia reader, such as indicia reader 100 (block 302). The method 300 may include analyzing the first image data to decode a first indicia associated with a first object in the first image data, resulting in a first indicia value (block 304).

The method 300 may include storing the first indicia value locally on a memory associated with the indicia reader (block 306). In some embodiments of the method 300, storing the first indicia value locally on the memory associated with the indicia reader (block 306) further includes retrieving one or more classified indicia values locally from the memory associated with the indicia reader, comparing the first indicia value to the one or more classified indicia values, and responsive to identifying a match between the first indicia value and a classified indicia value, one or more of (i) preventing the comparing of the second image data to the reference image data, or (ii) preventing the transmitting of the first indicia value to the host responsive to determining the second object is substantially similar to the first object.

The method 300 may further include transmitting the first indicia value to a host (block 308).

The method 300 may further include capturing a second image comprising second image data of a second object by a second imager (e.g., second imager 136, 204) having a second FOV of the objects passing across the scanning area of the indicia reader (block 310). In some embodiments of the method 300, the first imager is contained in a separate imaging device from the second imager.

The method 300 may include identifying the second object within the second image data (block 312). In some embodiments of the method 300, identifying the second object within the second image data (block 312) may include using a machine vision algorithm, and in embodiments the machine vision algorithm may include one or more of: (i) edge detection, (ii) pattern matching, (iii) segmentation, (iv) color analysis, (v) optical character recognition (OCR), or (vi) blob detection.

The method 300 may further include retrieving reference image data of the first object associated with the first indicia locally from the memory associated with the indicia reader (block 314).

The method 300 may include comparing the second image data to the reference image data to determine whether the second object is substantially similar to the first object (block 316). In some embodiments of the method 300, comparing the second image data to the reference image data to determine whether the second object is substantially similar to the first object further (block 316) further includes analyzing the second image data and the reference image data to generate a similarity value, comparing the similarity value to a threshold, and determining the second object is substantially similar to the first object based upon the similarity value at least reaching the threshold. In some embodiments of the method 300, comparing the second image data to the reference image data to determine whether the second object is substantially similar to the first object further (block 316) further includes applying a similarity model to the second image data to generate the determination whether the second object is substantially similar to the first object, the similarity model being trained on historical object image data, updating the historical object image data to include the second image data, and retraining the similarity model based upon the updated historical object image data.

The method 300 may further include determining whether the second object is substantially similar to the first object (block 318). The method 300 may include, responsive to determining the second object is substantially similar to the first object, transmitting the first indicia value to the host (block 320). In some embodiments of method 300, transmitting the first indicia value to the host (block 320) further comprises transmitting the first indicia value to the host without decoding a second indicia associated with the second object.

The method 300 may further include, responsive to determining that the second object is not substantially similar to the first object, capturing a third image comprising third image data of the second object by the first imager (block 322). In some embodiments, capturing the second image (block 310) and capturing the third image (block 322) may include capturing the second image and the third image substantially simultaneously.

The method 300 may include analyzing the third image data to decode a second indicia associated with the second object in the third image data, resulting in a second indicia value (block 324). The method may further include storing the second indicia value locally on the memory associated with the indicia reader (block 326). The method may include transmitting the second indicia value to a host (block 328).

In some embodiments, the method 300 may include removing the one or more indicia values that are stored locally on the memory responsive to one or more of: (i) a completion of a scan session at the indicia reader, (ii) a reboot of the indicia reader, or (iii) the memory associated with the particular indicia reader exceeding a storage limit.

### Additional Considerations

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method for rapid product identification, the method comprising:
capturing a first image comprising first image data of a first object by a first imager having a first field of view of objects passing across a scanning area of an indicia reader;
analyzing the first image data to decode a first indicia associated with a first object in the first image data, resulting in a first indicia value;
transmitting the first indicia value to a host;
storing the first indicia value locally on a memory associated with the indicia reader;
capturing a second image comprising second image data of a second object by a second imager having a second field of view of the objects passing across the scanning area of the indicia reader;
identifying the second object within the second image data;
retrieving reference image data of the first object associated with the first indicia locally from the memory associated with the indicia reader;
comparing the second image data to the reference image data to determine whether the second object is substantially similar to the first object; and
responsive to determining the second object is substantially similar to the first object, transmitting the first indicia value to the host.

2. The method of claim 1, comprising:
responsive to determining that the second object is not substantially similar to the first object, capturing a third image comprising third image data of the second object by the first imager;
analyzing the third image data to decode a second indicia associated with the second object in the third image data, resulting in a second indicia value;
transmitting the second indicia value to a host; and
storing the second indicia value locally on the memory associated with the indicia reader.

3. The method of claim 2, comprising:
capturing the second image and the third image substantially simultaneously.

4. The method of claim 1, comprising:
removing the one or more indicia values that are stored locally on the memory responsive to one or more of: (i) a completion of a scan session at the indicia reader, (ii) a reboot of the indicia reader, or (iii) the memory associated with the particular indicia reader exceeding a storage limit.

5. The method of claim 1, wherein identifying the second object within the second image data further comprises executing a machine vision algorithm locally on the indicia reader, the machine vision algorithm including one or more of: (i) edge detection, (ii) pattern matching, (iii) segmentation, (iv) color analysis, (v) optical character recognition (OCR), or (vi) blob detection.

6. The method of claim 1, wherein storing the first indicia value locally on the memory associated with the indicia reader further comprises:
retrieving one or more classified indicia values locally from the memory associated with the indicia reader;
comparing the first indicia value to the one or more classified indicia values; and
responsive to identifying a match between the first indicia value and a classified indicia value, one or more of:
preventing the comparing of the second image data to the reference image data, or
preventing the transmitting of the first indicia value to the host responsive to determining the second object is substantially similar to the first object.

7. The method of claim 1, wherein comparing the second image data to the reference image data to determine whether the second object is substantially similar to the first object further comprises:
analyzing the second image data and the reference image data to generate a similarity value;
comparing the similarity value to a threshold; and
determining the second object is substantially similar to the first object based upon the similarity value at least reaching the threshold.

8. The method of claim 1, wherein comparing the second image data to the reference image data to determine whether the second object is substantially similar to the first object further comprises:
applying a similarity model to the second image data to generate the determination whether the second object is substantially similar to the first object, the similarity model being trained on historical object image data;
updating the historical object image data to include the second image data; and
retraining the similarity model based upon the updated historical object image data.

9. The method of claim 1, wherein the first imager is contained in a separate imager from the second imager.

10. The method of claim 1, wherein transmitting the first indicia value to the host further comprises transmitting the first indicia value to the host without decoding a second indicia associated with the second object.

11. A scanning system for rapid product identification comprising:
a first imager having a first field of view of objects passing across a scanning area of an indicia reader configured to capture a first image comprising image data of a first object;
a second imager having a second of view of the objects passing across the scanning area of the indicia reader configured to capture a second image comprising second image data of a second object;
one or more processors; and
a memory associated with the particular indicia reader storing instructions that, when executed by the one or more processors, cause the one or more processors to:
analyze the first image data to decode a first indicia associated with a first object in the first image data, resulting in a first indicia value;
transmit the first indicia value to a host;
store the first indicia value locally on the memory associated with the indicia reader;
identify the second object within the second image data;
retrieve reference image data of the first object associated with the first indicia locally from the memory associated with the indicia reader;
compare the second image data to the reference image data to determine whether the second object is substantially similar to the first object; and
responsive to determining the second object is substantially similar to the first object, transmit the first indicia value to the host.

12. The scanning system of claim 11, wherein the one or more processors are further configured to:
responsive to determining that the second object is not substantially similar to the first object, cause the first imager to capture a third image comprising third image data of the second object;
analyze the third image data to decode a second indicia associated with the second object in the third image data, resulting in a second indicia value;
transmit the second indicia value to a host; and
store the second indicia value locally on the memory associated with the indicia reader.

13. The scanning system of claim 12, wherein the one or more processors are further configured to:
cause the first imager and the second imager to substantially simultaneously capture the second image and the third image.

14. The scanning system of claim 11, wherein the one or more processors are further configured to:
remove the one or more indicia values that are stored locally on the memory responsive to one or more of: (i) a completion of a scan session at the indicia reader, (ii) a reboot of the indicia reader, or (iii) the memory associated with the particular indicia reader exceeding a storage limit.

15. The scanning system of claim 11, wherein to identify the second object within the second image data, the one or more processors are further configured to execute a machine vision algorithm locally on the indicia reader, the machine vision algorithm including one or more of: (i) edge detection, (ii) pattern matching, (iii) segmentation, (iv) color analysis, (v) optical character recognition (OCR), or (vi) blob detection.

16. The scanning system of claim 11, wherein to store the first indicia value locally on the memory associated with the indicia reader, the one or more processors are further configured to:
retrieve one or more classified indicia values locally from the memory associated with the indicia reader;
compare the first indicia value to the one or more classified indicia values; and
responsive to identifying a match between the first indicia value and a classified indicia value, one or more of:
preventing the comparing of the second image data to the reference image data, or
preventing the transmitting of the first indicia value to the host responsive to determining the second object is substantially similar to the first object.

17. The scanning system of claim 11, wherein to compare the second image data to the reference image data to determine whether the second object is substantially similar to the first object, the one or more processors are further configured to:
analyze the second image data and the reference image data to generate a similarity value;
compare the similarity value to a threshold value; and
determine the second object is substantially similar to the first object based upon the similarity value at least meeting the threshold value.

18. The scanning system of claim 11, wherein to compare the second image data to the reference image data to determine whether the second object is substantially similar to the first object, the one or more processors are further configured to:
apply a similarity model to the second image data to generate a determination whether the second object is substantially similar to the first object, the similarity model being trained on historical object image data;
update the historical object image data to include the second image data; and
retrain the similarity model based upon the updated historical object image data.

19. The scanning system of claim 11, wherein the first imager is contained in a separate imager from the second imager.

20. A tangible machine-readable medium comprising instructions that, when executed, cause a machine to at least:
capture a first image comprising first image data of a first object by a first imager having a first field of view of objects passing across a scanning area of an indicia reader;
analyze the first image data to decode a first indicia associated with a first object in the first image data, resulting in a first indicia value;
transmit the first indicia value to a host;
store the first indicia value locally on a memory associated with the indicia reader;
capture a second image comprising second image data of a second object by a second imager having a second field of view of the objects passing across the scanning area of the indicia reader;
identify the second object within the second image data;
retrieve reference image data of the first object associated with the first indicia from a local memory associated with the indicia reader;
compare the second image data to the reference image data to determine whether the second object is substantially similar to the first object; and
responsive to determining the second object is substantially similar to the first object, transmit the first indicia value to the host.

21-40. (canceled)
